(19) United States
(12) Patent Application Publication
(10) Pub. No.: US 2025/0053141 A1
(43) Pub. Date: Feb. 13, 2025

(54) METHOD FOR REPLACING A FIELD DEVICE WITH A FIELD DEVICE IN A MEASURING STATION OF AN AUTOMATION TECHNOLOGY SYSTEM

(71) Applicant: Endress+Hauser Process Solutions AG, Reinach (CH)

(72) Inventors: Bert von Stein, Zell i. W. (DE); Martine Lefebvre, Blotzheim (FR); Gregor Pfirter, Reinach (CH); Peter Hohm, Lörrach (DE)

(21) Appl. No.: 18/720,029

(22) PCT Filed: Nov. 28, 2022
(86) PCT No.: PCT/EP2022/083464

§ 371 Date: Jun. 14, 2024

(30) Foreign Application Priority Data
Dec. 21, 2021 (DE) 10 2021 133 959.6

(51) Int. Cl. G05B 11/40

(52) U.S. Cl. CPC G05B 11/40

(57) ABSTRACT

The present disclosure relates to a pressure transducer comprising a process module having a cylindrical main part made of a first material. A pressure-sensitive process diaphragm and an axially disposed through-hole are provided in the main part. The pressure transducer includes a measuring module having a cylindrical base which is manufactured from a second material that differs from the first material. The base has a pressure sensor and a pin-like portion, where the pin-like portion projects into the through-hole such that an end portion of the pin-like portion is flush with the end portion of the main part facing the medium. The end portion of the pin-like portion is connected to the end portion of the main part facing the medium, where the pin-like portion tapers in the direction of the end portion of the pin-like portion.

The invention relates to a method for replacing a field device with a replacement field device in a measuring station of an automation technology system, wherein: the field device and the replacement field device are of a different device type and/or different device version from one another; a first digital twin is assigned to the field device; a second digital twin is assigned to the replacement field device; the first digital twin has a first model relating to the field device; the second digital twin has a second model relating to the replacement field device; the field device and the first model each contain identical first device properties, comprising first device parameters, an identical first logic, identical first events and identical first commands; and the replacement field device and the second model each contain identical second device properties, comprising device parameters, an identical second logic, identical second events and identical second commands.

Field devices that are used in industrial installations are already known from the prior art. Field devices are often used in process automation engineering, as well as in manufacturing automation engineering. In principle, all devices which are process-oriented and which supply or process process-relevant information are referred to as field devices. Field devices are thus used for detecting and/or influencing process variables. Measuring devices, or sensors, are used for detecting process variables. These are used, for example, for pressure and temperature measurement, conductivity measurement, flow measurement, pH measurement, fill level measurement etc., and detect the corresponding process variables of pressure, temperature, conductivity, pH value, fill level, flow etc. Actuators are used for influencing process variables. These are, for example, pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level.

A multitude of such field devices is produced and marketed by the Endress+Hauser group.

In modern industrial plants, field devices are usually connected to superordinate units via communication networks such as fieldbuses (Profibus®, Foundation® Fieldbus, HART® etc.). Usually, the superordinate units are control systems (DCS) or control units, such as an SPC (stored program control). The superordinate units are used for, among other things, process control, process visualization, and process monitoring, as well as commissioning of the field devices. The measured values recorded by the field devices, especially by sensors, are transmitted via the respective bus system to a (or in some cases a plurality of) superordinate unit(s). In addition, data transmission from the superordinate unit via the bus system to the field devices is also required, especially for configuration and parameterization of field devices and for controlling actuators.

As part of Industry 4.0 or IIoT (“industrial Internet of Things”), the data generated by the field devices are also frequently collected directly from the field by means of what are known as data conversion units, which are referred to as “edge devices” or “cloud gateways,” for example, and are transmitted automatically to a central cloud-enabled database (also termed a cloud for short) having an application. This application, which inter alia offers functions for visualizing and further processing the data stored on the database, can be accessed by a user by means of the Internet.

A different device type or a newer device version of the field device to be replaced is frequently used to replace a field device in existing or planned plant configurations, for example if older device types or device versions are no longer available. In such a case, an adaptation of the plant configuration at the control system level is necessary, which is complex and very expensive.

In order to ensure compatibility with a field device of a different device type or older device versions of a field device, backward compatibility in the form of a special mode is generally programmed within the device firmware. Alternatively, an additional device firmware variant is also used. However, device parameters, unit codes, or Modbus registers from older device types can be incompatible in modern plants, since new standards require corresponding new definitions. Diagnostic codes and their behavior are also important for older plants, but are often incompatible with the newer requirements of the same diagnostics (in particular NAMUR-based).

The effort and upkeep associated with these compatibility topics within the device firmware are very complex. For example, the behavior of an older firmware version must be mapped in the new architecture of the current firmware version. In addition, these compatibility topics are often associated with certification work.

Furthermore, the existing memory in a field device, which is typically designed as an embedded device, is very limited. The result is that only very few of these compatibilities can actually be mapped. Configuring the compatibility mode or flashing the alternative firmware for each field device in use is also very time-consuming. In addition, the compatibilities produced are difficult to update.

Proceeding from this problem, the invention is based on the object of specifying a method which enables the compatibility of a field device to be replaced with a replacement field device.

The object is achieved by a method for replacing a field device with a replacement field device in a measuring station of an automation technology system, wherein the field device and the replacement field device are of a different device type and/or different device version from one another; a first digital twin is assigned to the field device; a second digital twin is assigned to the replacement field device; the first digital twin has a first model relating to the field device; the second digital twin has a second model relating to the replacement field device; the field device and the first model each contain identical first device properties, comprising first device parameters, an identical first logic, identical first events and identical first commands; and the replacement field device and the second model each contain identical second device properties, comprising second device parameters, an identical second logic, identical second events and identical second commands; said method comprising:
physically replacing the field device with the replacement field device in the measuring station; and
accessing the first digital twin and operating the replacement field device based on the second device properties and at least some of the first device properties.

The core of the method according to the invention consists in the fact that, instead of adapting the device firmware of the replacement field device, the digital twin of the field device to be replaced is used to provide compatibility. For this purpose, the first digital twin of the field device to be replaced continues on after the replacement.

A digital twin, also called a digital image, is a virtual representation of the field device which has the same configuration, parameter values, current device status, algorithms, etc. as the field device. The digital twin therefore has all the properties of the field device which describe the field device in full for its intended purpose. It is provided that the field device and the digital twin are always identical. A change in properties of the field device leads to synchronization (via Industry 4.0, or IIoT technologies) so that the properties of the digital twin are updated accordingly.

Since the device properties of the digital twin of the replacement field device correspond to those of the field device to be replaced, these can be used to provide functionalities of this field device and therefore to ensure compatibility. The field device and the replacement field device can also be different device types. This means that the field devices each record the same physical measurement variable of a processing procedure, or each influence the same physical measurement variable of a processing procedure, but this can be achieved by means of different physical measurement methods or actuator methods. If, for example, a fill level is to be measured, the field device to be replaced can be a radar-based fill level measuring device, wherein the replacement field device is a guided fill level measuring device. In the case of an actuator which changes the flow through a pipeline, the field device and the replacement field device can be pumps or valves of different types. For a person skilled in the art, it goes without saying that a completely incompatible field device types cannot be replaced using the method. For example, it is impossible to replace a pressure measuring device with a temperature sensor, since the physical variable that is to be recorded is different.

Field devices that are described in connection with the method according to the invention are already listed and defined as examples in the introductory part of the description.

According to a first variant of the method according to the invention, it is provided that the replacement field device submits a request via the second digital twin to the first digital twin, wherein the at least some of the first device properties are loaded from the first digital twin to the second digital twin as a result of the request, and wherein the second device properties and the at least some of the first device properties are transferred from the second digital twin to the field device. In particular, the replacement field device is a field device which can establish a second communication channel. The first communication channel is the classic communication channel which is established via a fieldbus or a communication loop with a superordinate unit. A second communication channel is established via a local network or the Internet (for example by mobile radio network) with a server/cloud or a network device. Via the second communication channel, the replacement field device establishes a connection to its (second) digital twin and thereby retrieves the required device properties of the field device to be replaced.

In an advantageous embodiment of the second variant of the method according to the invention, it is provided that the replacement field device executes its functionalities on the basis of the second device properties and at least some of the first device properties. Precisely those device properties which are required to establish compatibility (i.e. the state in which the replacement field device reliably executes the functionalities of the field device to be replaced) are therefore retrieved from the first digital twin.

An advantageous embodiment of the second variant of the method according to the invention provides that the first digital twin and the second digital twin are arranged on a common entity, in particular a cloud or a network device, for example a control unit, a gateway or an edge device. In particular, the entity is integrated as a cloud application on the cloud. A cloud application is a program that runs on a cloud-based platform (termed cloud for short) or a server, or is integrated therein. The terms cloud-based platform, cloud and server are to be understood as synonymous within the scope of this application. The cloud can be reached by Internet. A user can connect to the cloud-based platform via the Internet and perform modifications in the corresponding cloud applications of the cloud-based platform and/or operate them, i.e., write data into the cloud applications, read data from the cloud applications, and/or edit said data.

In an advantageous embodiment of the second variant of the method according to the invention, it is provided that the first digital twin and the second digital twin are arranged on separate entities, in particular on a cloud or each on a network device in each case.

Furthermore, in the event that the two separate entities are of different types or incompatible with one another, it is provided to use a translation module, wherein the data traffic runs between the two entities via the translation module, and wherein the translation module converts the data traffic of a transmitting entity into a format compatible with a receiving entity.

According to a second variant of the method according to the invention, it is provided that a superordinate unit is provided which is communicatively connected to the replacement field device, wherein the superordinate unit operates the replacement field device by the superordinate unit having access to the first digital twin and the second digital twin and downloads the second device properties and the at least some of the first device properties from the corresponding digital twin. The superordinate unit, for example a control unit such as a PLC or the like, accordingly controls the field device and retrieves raw and/or measurement data from the field device. The compatibility (i.e. the state in which the replacement field device reliably executes the functionalities of the field device to be replaced) is produced by retrieving the correspondingly required device properties of the field device to be replaced.

In an advantageous embodiment of the second variant of the method according to the invention, it is provided that the superordinate unit receives raw data from the field device for operating the field device and further processes this raw data on the basis of the second device properties and at least some of the first device properties.

The invention is explained in greater detail with reference to the following drawings. In the drawings:

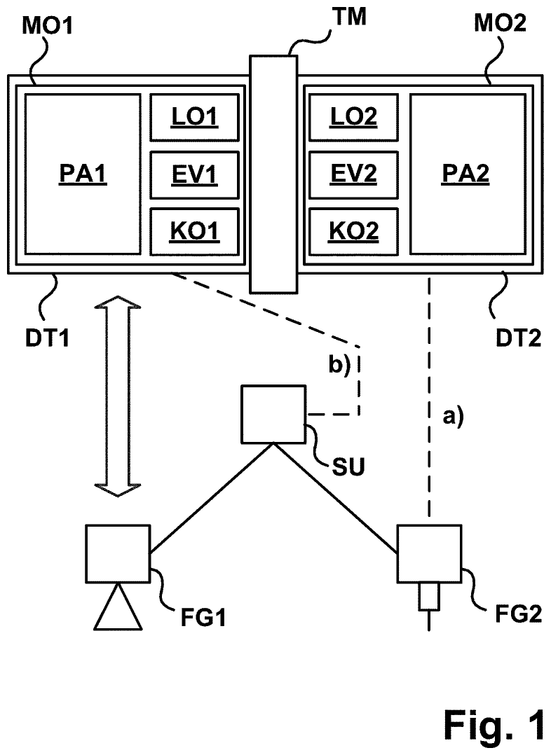

FIG. 1 shows an embodiment of the method according to the invention.

FIG. 1 shows a field device FG1 which is to be replaced due to aging. The field device FG1 is a contact-free radar-based fill level measuring device which is designed to record the fill level of a process medium in a container. The field device FG1 is communicatively connected via a wired communication network, in particular a 4-20 mA/HART communication loop or a field bus, to a superordinate unit SU, for example a programmable logic controller, which retrieves current measured values from the field device FG1 at regular intervals and which is used to operate the field device FG1, in particular to retrieve status information and/or diagnostic data and to set parameter values.

When used as intended, the field device has a plurality of first device properties, containing parameter values PA1 (these define, among other things, the measuring operation of the field device FG1), a first logic LO1 (this determines, for example, how recorded raw measured values are processed), first events EV1 (for example, a list of events/state changes of the field device FG1), and first commands KO1 (these define, for example, how protocol-compliant standard commands of the communication network are implemented at device level).

A first digital twin DT1 is assigned to the field device FG1. In the present example, the first digital twin DT1 is integrated in an application of a cloud. A digital twin is a virtual representation of a field device which behaves in the exact same way as the physical field device. For this purpose, the first digital twin DT1 has a first model MO1 of the field device FG1 which has all the first device properties PA1, LO1, EV1, KO1 of the field device FG1. A digital twin is designed such that any change in the device properties of the field device leads to the same change in the device properties in the digital twin, or vice versa.

The field device FG1 is now to be replaced with a replacement field device FG2. The replacement field device FG2 is a field device of a different device type, in the present case a guided radar-based fill level measuring device. The replacement field device FG2 differs in many ways from the field device FG1 with regard to the device properties. A corresponding second digital twin DT2 is assigned to the replacement field device FG2. The digital twin DT1 of the field device FG1 still exists, even if the field device FG1 is removed.

In the following, two different design variants will describe how compatibility between the replacement field device FG and the field device FG1 can be achieved:

In the variant denoted by a) in FIG. 1, the replacement field device FG2 is configured as a replacement device of the field device FG1 before installation. In addition to the possibility of communicating via the first communication channel (4-20 mA/HART communication loop, or fieldbus), the replacement field device FG has an additional communication interface via which it can communicate with its digital twin DT2 using a second communication channel (for example by mobile radio).

Via the second communication channel, the replacement field device FG now submits a request to its digital twin DT2 to provide compatibility. The second digital twin DT2 then engages in a replacement with the first digital twin DT1. In this case, a check is made as to which device properties in the first model MO1 are different from the device properties in the second model MO2. The device properties that are not present in the second model MO2 are then transmitted from the first model MO1 to the second model MO2. If the device properties of the two models MO1, MO2 are in a different format (since, for example, the development platform of both field devices FG1, FG2 is different), or if the two digital twins are on applications of different clouds, a translation module in an interpreter mode establishes data compatibility between the two digital twins DT1, DT2 (e.g. using translation tables and/or an AI algorithm). In the event that data compatibility between the two digital twins DT1, DT2 exists from the outset, the translation module TM is not required, or the translation module TM switches into a transparent mode.

After the required device properties have been copied from the first model MO1 to the second model MO2, synchronization takes place between the second digital twin DT2 and the replacement field device FG2 so that the replacement field device FG2 also has the missing device properties of the field device FG1. The replacement field device FG2 is then operated on the basis of the updated device properties.

In the variant denoted in FIG. 1 by b), it is not the replacement field device FG2, but rather the superordinate unit SU, that is communicatively connected to the entity, or the entities, on which the digital twins are arranged, for example via the Internet. The superordinate unit SU is designed to record raw data of the replacement field device FG2 and further process it according to the second device properties, or to further process the replacement field device FG on the basis of the second device properties. The superordinate unit SU receives the second device properties from the second digital twin DT2.

In order to establish compatibility, the superordinate unit SU sends the corresponding request to the first digital twin DT1. Said twin transmits the corresponding missing first device parameters to the superordinate unit SU. Here, too, the translation module TM may be used. The superordinate unit SU then operates the replacement field device FG2 on the basis of the updated device properties.

The present embodiment relates to a replacement field device FG2, the device type of which differs from the original field device FG1 to be replaced. However, the method can also be used for scenarios in which the replacement field device FG2 has a different, for example newer and/or incompatible, firmware version with respect to the original field device FG1 to be replaced.

It can also be provided that the digital twins are on one or more network devices, for example edge devices or gateways or local PCs instead of on cloud applications. However, the general procedure of the method is analogous here.

### LIST OF REFERENCE SIGNS

DT1 First digital twin
DT2 Second digital twin
EV1 First events
EV2 Second events
FG1 Field device
FG2 Replacement field device
KO1 First commands
KO2 Second commands
LO1 First logic
LO2 Second logic
MO1 First model
MO2 Second model
PA1 First device parameters
PA2 Second device parameters
SU Superordinate unit
TM Translation module

1-15. (canceled)

16. A pressure transducer for determining a first pressure of a medium, comprising:
a process module with a cylindrical main part made of a first material,
wherein a pressure-sensitive process diaphragm is provided in an end portion of the main part facing the medium,
the main part having an axially disposed through-hole which tapers towards the end portion of the main part facing the medium,
a measuring module with a cylindrical base, the process module and the measuring module being axially aligned with respect to one another and connected to one another in a respective connecting region of a respective end face of the process module and of the measuring module, the base being made of a second material which differs from the first material, the base having a pressure sensor and a pin-like portion,
wherein the pin-like portion projects into the through-hole in such a way that an end portion of the pin-like portion is flush with the end portion of the main part facing the medium, wherein the end portion of the pin-like portion is connected to the end portion of the main part facing the medium, wherein the pin-like portion tapers in the direction of the end portion of the pin-like portion, wherein the pin-like portion has a capillary which is designed to transmit the first pressure of the medium from the process diaphragm to a first surface of the pressure sensor,
wherein the pressure sensor is subjected to a second pressure on a second surface opposite the first surface.

17. The pressure transducer according to claim 16,
wherein the first material is a corrosion-resistant material.

18. The pressure transducer according to claim 16,
wherein the second material is less corrosion-resistant than the first material.

19. The pressure transducer according to claim 16,
wherein the first material is a nickel alloy.

20. The pressure transducer according to claim 16,
wherein the first material is Hastelloy, Inconel or Monel.

21. The pressure transducer according to claim 16,
wherein the second material is a steel.

22. The pressure transducer according to claim 16,
wherein the respective connecting region of the end face of the process module and the end face of the measuring module is ring-shaped.

23. The pressure transducer according to claim 16,
wherein the connecting region of the process module and/or the connecting region of the measuring module is designed as a step, shoulder, projection or edge, the connecting region of the process module and the connecting region of the measuring module being designed to correspond to one another.

24. The pressure transducer according to claim 16,
wherein the process module and the measuring module are in contact exclusively in the respective connecting region and between the end portion of the pin-like portion and the end portion of the main part facing the medium.

25. The pressure transducer according to claim 16,
wherein the process module and the measuring module are connected in the respective connecting region of the respective end face by means of a first weld, the end portion of the pin-like portion being connected to the end portion of the main part facing the medium using a second weld.

26. The pressure transducer according to claim 16,
wherein a pin is disposed inside the capillary, which is designed in such a way that the pin acts together with the capillary as a flashback arrestor.

27. The pressure transducer according to claim 16,
wherein the main part of the process module has an attachment region for a connection to a process connection.

28. The pressure transducer according to claim 16,
wherein the pressure sensor is separated from at least one electronic unit using an electrically insulating feed-through element, which is inserted into a recess in the base.

29. The pressure transducer according to claim 16,
wherein the second pressure is an absolute pressure or a reference pressure, wherein in the case of the reference pressure, the base has a reference air bore which is designed to guide the reference pressure through the base to the second surface of the pressure sensor.

30. A differential pressure transducer for determining a differential pressure from a first pressure and a second pressure, comprising:
two process modules, each with a cylindrical main part made of a first material,
a pressure-sensitive process diaphragm being provided in each end portion of the main part facing the medium, wherein the first process diaphragm is subjected to the first pressure, and the second process diaphragm is subjected to the second pressure,
the main part having an axially disposed through-hole which tapers towards the end portion of the main part facing the medium,
a measuring module with a cylindrical base, the two process modules each being aligned axially to the measuring module and connected to one another in a respective connecting region of a respective end face of the respective process module and a respective end face of the measuring module, the base being made of a second material which differs from the first material, the base having a pressure sensor and two pin-like portions,
wherein the two pin-like portions each project into the through-hole of the respective main part in such a way that one end portion of the pin-like portion is flush with the respective end portion of the main part facing the medium, the respective end portion of the pin-like portion being connected to the respective end portion of the main part facing the medium, the two pin-like portions tapering in the direction of their respective end portion, the two pin-like portions having a first capillary and a second capillary, the first capillary being designed to transmit the first pressure from the first process diaphragm to a first surface of the pressure sensor, and the second capillary being designed to transmit the second pressure from the second process diaphragm to a second surface of the pressure sensor opposite the first surface.
